(19) United States
(12) Patent Application Publication
(10) Pub. No.: US 2015/0295239 A1
(43) Pub. Date: Oct. 15, 2015

(54) POSITIVE-ELECTRODE ACTIVE MATERIAL FOR LITHIUM-ION SECONDARY BATTERY AND LITHIUM-ION SECONDARY BATTERY COMPRISING THE SAME

(71) Applicant: KABUSHIKI KAISHA TOYOTA JIDOSHOKKI, Kariya-shi, Aichi (JP)

(72) Inventors: Masanori HARATA, Kariya-shi (JP); Dai MATSUSHIRO, Kariya-shi (JP)

(73) Assignee: KABUSHIKI KAISHA TOYOTA JIDOSHOKKI, Kariya-shi, Aichi (JP)

(21) Appl. No.: 14/439,436

(22) PCT Filed: Oct. 31, 2013
(86) PCT No.: PCT/JP2013/006463

§ 371 Date: Apr. 29, 2015

(30) Foreign Application Priority Data
Nov. 12, 2012 (JP) 2012-248640
Jan. 31, 2013 (JP) 2013-016851

(51) Int. Cl. H01M 4/525; H01M 10/0525; H01M 4/62; H01M 4/36; H01M 4/505

(52) U.S. Cl. CPC H01M 4/525; H01M 4/366; H01M 4/505; H01M 4/62; H01M 10/0525

(57) ABSTRACT

Providing a positive-electrode active material for lithium-ion secondary battery, the positive-electrode active material contributing to upgrading the rate characteristic and cyclability, and providing a lithium-ion secondary battery including the same.

The positive-electrode active material includes a positive-electrode active-material body, and an adhesion portion adhering on at least some of a surface of the positive-electrode active-material body. The adhesion portion is composed of a compound expressed by a chemical formula: (ZrO)₂P₂O₇.

### TECHNICAL FIELD

The present invention relates to a positive-electrode active material for lithium-ion secondary battery, and a lithium-ion secondary battery comprising the same.

### BACKGROUND ART

In recent years, as being accompanied by the developments of cellular phones and notebook-size personal computers, and by electric automobiles being put to practical use, small-sized, lightweight and high-capacity secondary batteries have been required. At present, as for high-capacity secondary batteries, lithium-ion secondary batteries using lithium cobaltate (e.g., LiCOO₂) as the positive-electrode material and a carbon-based material as the negative-electrode material have been commercialized.

In the lithium-ion secondary batteries, making the capacity much higher has been sought for, so that various investigations have been carried out as to active materials used in the lithium-ion secondary batteries. Substances being capable of inserting and eliminating (or sorbing and desorbing) lithium thereinto and therefrom respectively have been used commonly. Consequently, the active materials are sought to have a structure being stable even when the insertion and elimination of lithium take place at the time of charging and discharging. In order to enhance the structural stability of active material, investigations have been carried out to form a surface-treated layer on a surface of the active material.

Patent Application Publication No. 1 (i.e., Japanese Unexamined Patent Publication (KOKAI) Gazette No. 2003-7299) sets forth an active material with a surface-treated layer formed on the surface. The surface-treated layer includes a compound being expressed by such a chemical formula as MXOₖ (where “M” is at least one element selected from the group consisting of alkali metals, alkaline-earth metals, group-13 elements, group-14 elements, transition metals and rare-earth elements; “X” is an element being able to form a double bond with oxygen; and “k” is from 2 to 4). In examples according to Patent Application Publication No. 1, the following are set forth: LiCoO₂ with an AlPO₄ layer formed, and LiNi_{0.8}Mn_{0.2}O₂ with an AlPO₄ layer formed. Patent Application Publication No. 1 sets forth that batteries comprising the active materials with the aforementioned surface-treated layer formed have upgraded rate characteristic and cyclability and further excel in the thermal stability as well.

### PATENT LITERATURE

Patent Application Publication No. 1: Japanese Unexamined Patent Publication (KOKAI) Gazette No. 2003-7299

### SUMMARY OF THE INVENTION

### Technical Problem

As mentioned above, various investigations have been carried out in order to enhance the structural stability of active material. The present invention is made in view of such circumstances. An object of the present invention is to provide the following: a positive-electrode active material for lithium-ion secondary battery, the positive-electrode active material enhancing the structural stability of active material by a new method and thereby being able to improve the rate characteristic and cyclability; and a lithium-ion secondary battery comprising the same.

### Solution to Problem

As a result of wholehearted investigations by the present inventors, the present inventors found out that adhering a compound expressed by a chemical formula: (ZrO)₂P₂O₇ onto at least some of the surface of a positive-electrode active-material body results in making the following improvable: the rate characteristic, cyclability, initial charge/discharge efficiency and storage property. The compound expressed by the chemical formula: (ZrO)₂P₂O₇ is not equivalent to the compound set forth in Patent Application Publication No. 1. The present inventors newly found out advantageous effects of the compound expressed by the chemical formula: (ZrO)₂P₂O₇.

That is, a positive-electrode active material for lithium-ion secondary battery according to the present invention comprises: a positive-electrode active-material body; and an adhesion portion adhering on at least some of a surface of the positive-electrode active-material body. The adhesion portion is composed of a compound expressed by a chemical formula: (ZrO)₂P₂O₇.

A preferable proportion occupied by an area of the adhesion portion is from 4% or more to 60% or less when the total surface area of the positive-electrode active-material body is taken as 100%.

A preferable proportion occupied by an area of the adhesion portion is from 1% or more to 36% or less when the total surface area of the positive-electrode active-material body is taken as 100%.

The aforementioned positive-electrode active material for lithium-ion secondary battery is preferably produced via a heating step, wherein the temperature is from 150° C. or more to 500° C. or less.

The positive-electrode active-material body is preferably composed of a lithium-containing compound expressed by a chemical formula: LiMO₂ (where “M” is at least one member selected from the group consisting of Ni, Co and Mn).

The positive-electrode active-material body is more preferably composed of the lithium-containing compound expressed by a chemical formula: LiCoₚNi_{q}MnᵣO₂ (where “p”+“q”+“r”=1; 0<“p”<1; 0<“q”<1; and 0<“r”<1).

A lithium-ion secondary battery according to the present invention comprises the positive-electrode active material for lithium-ion secondary battery according to the present invention.

### Advantageous Effects of the Invention

In the positive-electrode active material for lithium-ion secondary battery according to the present invention, the (ZrO)₂P₂O₇ adheres at least some of a surface of the positive-electrode active-material body. Consequently, the rate characteristic and cyclability of the present lithium-ion secondary battery are improvable.

### BRIEF DESCRIPTION OF THE DRAWINGS

FIG. 1 is a schematic cross-sectional diagram explaining a positive-electrode active material according to one of the present examples;

FIG. 2 is the result of a powder X-ray diffraction (or XRD) of an adhered substance in a positive-electrode active material according to a first example of the present invention; and

FIG. 3 is a graph showing the result of a thermogravimetric measurement (i.e., thermogravimetry (or TG)) of (ZrO)₂P₂O₇.

### EXPLANATION ON REFERENCE NUMERALS

1: Positive-electrode Active-material Body; and

2: Adhesion Portion

### DESCRIPTION OF THE EXAMPLES

### Positive-Electrode Active Material for Lithium-ion Secondary Battery

A positive-electrode active material for lithium-ion secondary battery according to the present invention comprises: a positive-electrode active-material body; and an adhesion portion adhering on at least some of a surface of the positive-electrode active-material body. The adhesion portion is composed of a compound expressed by a chemical formula: (ZrO)₂P₂O₇.

As for the positive-electrode active-material body, a lithium-containing compound, or another metallic compound is usable. As for the lithium-containing compound, the following are usable: lithium/cobalt composite oxides with a lamellar structure, lithium/nickel composite oxides with a lamellar structure, lithium/manganese composite oxides with a spinel structure, lithium/phosphate composite oxides with an olivine structure, and the like, for instance.

Moreover, as for the other metallic compound, the following are given: oxides such as titanium oxide, vanadium oxide and manganese dioxide, or disulfides such as titanium sulfide and molybdenum sulfide.

A preferable positive-electrode active-material body is composed of a lithium-containing compound expressed by a chemical formula: LiMO₂ (where “M” is at least one member selected from the group consisting of Ni, Co and Mn). In addition, a more preferable positive-electrode active-material body is composed of the lithium-containing compound expressed by a chemical formula: LiCoₚNi_{q}MnᵣO₂ (where “p”+“q”+“r”=1; 0<“p”<1; 0<“q”<1; and 0<“r”<1).

As for the lithium-containing compound, the following are usable: LiCo_{1/3}Ni_{1/3}Mn_{1/3}O₂, LiNi_{0.6}CO_{0.2}Mn_{0.2}O₂, LiNi_{0.5}Co_{0.2}Mn_{0.3}O₂, LiCoO₂, LiN_{0.8}Co_{0.2}O₂, or LiCoMnO₂. Among the lithium-containing compounds, LiCo_{1/3}Ni_{1/3}Mn_{1/3}O₂, or LiNi_{0.5}Co_{0.2}Mn_{0.3}O₂ is preferable in terms of the thermal stability.

A preferable positive-electrode active-material body has a powdery configuration exhibiting from 1 μm to 20 μm in the average particle diameter. When the average particle diameter of the positive-electrode active-material body is smaller than 1 μm, the specific surface area of the positive-electrode active-material body becomes large. Consequently, the reactive area between the positive-electrode active material and an electrolytic solution increases. Moreover, when the average particle diameter of the positive-electrode active-material body is larger than 20 μm, the resistance becomes large upon making the positive-electrode active-material body into a lithium-ion secondary battery. Consequently, the charged and discharged capacities of the lithium-ion secondary battery lower. The average particle diameter of the positive-electrode active-material body is measureable instrumentally by a particle-size distribution measurement technique.

The adhesion portion adheres on at least some of a surface of the positive-electrode active-material body. The adhesion portion is composed of a compound expressed by a chemical formula: (ZrO)₂P₂O₇. Note herein that the compound expressed by the chemical formula: (ZrO)₂P₂O₇ naturally includes not only the compound free from crystal water but also the compound with crystal water. That is, the compound expressed by the chemical formula: (ZrO)₂P₂O₇ naturally includes not only the compound not being hydrate but also the compound being hydrate. The compound expressed by the chemical formula: (ZrO)₂P₂O₇ is hereinafter referred to as (ZrO)₂P₂O₇.

A commercially available product is usable for the (ZrO)₂P₂O₇, or the (ZrO)₂P₂O₇ is also preferably made by a procedure set forth below, for instance. A hydrate of the (ZrO)₂P₂O₇ is precipitated by dissolving ZrO(NO₃)₂.2H₂O and (NH₄)₂HPO₄.6H₂O in pure water in a constant proportion to each other. The precipitated hydrate of the (ZrO)₂P₂O₇ has been turned into an amorphous state. And, the precipitated hydrate of the (ZrO)₂P₂O₇ is dried. In addition, when the dried hydrate of the (ZrO)₂P₂O₇ is heated at 150° C. or more, water content contained inside decreases. In particular, the dried hydrate of the (ZrO)₂P₂O₇ is heated preferably at 400° C. or more. Calcining the dried hydrate of the (ZrO)₂P₂O₇ at 400° C. or more results in taking away most of crystal water in the hydrate of the (ZrO)₂P₂O₇ so that the hydrate turns into the (ZrO)₂P₂O₇, and thereby the crystallinity goes up.

The (ZrO)₂P₂O₇ preferably has a less water content. The less the (ZrO)₂P₂O₇ has a water content, the less the resistance of battery can be made. Consequently, the less the (ZrO)₂P₂O₇ has a water content, the higher making the charged and discharged capacities is possible. Moreover, the (ZrO)₂P₂O₇ is believed to deteriorate by a contained water content. Consequently, the less the (ZrO)₂P₂O₇ has a water content, the more remarkably the positive-electrode active-material body effects such an advantage as facilitating the lithium-ion conduction.

Preferably, the aforementioned (ZrO)₂P₂O₇ has a powdery configuration exhibiting 500 nm or less in the average particle diameter. When the average particle diameter of the (ZrO)₂P₂O₇ is larger than 500 nm, adhering at least one piece of the (ZrO)₂P₂O₇ onto a surface of at least one piece of the positive-electrode active-material body is difficult. The average particle diameter of the (ZrO)₂P₂O₇ is measure able instrumentally by a particle-size distribution measurement technique.

Moreover, a preferable average particle diameter of a powder of the positive-electrode active-material body is larger than the average particle diameter of a powder of the (ZrO)₂P₂O₇. When the positive-electrode active-material body is larger than the (ZrO)₂P₂O₇, the (ZrO)₂P₂O₇ is likely to adhere on a surface of the positive-electrode active-material body.

In a surface of the positive-electrode active-material body, an allowable adhesion portion adheres on at least some of the surface. The (ZrO)₂P₂O₇ is higher in the lithium-ion conductivity than the positive-electrode active-material body. When the (ZrO)₂P₂O₇ exists on some of a surface of the positive-electrode active-material body, the lithium-ion conduction takes place selectively in the vicinity of the (ZrO)₂P₂O₇. That is, at places on which the (ZrO)₂P₂O₇ does not adhere, the lithium-ion conduction is less likely to occur. The decompositions of electrolytic solution take place generally at locations where the lithium-ion conduction takes place in a surface of the positive-electrode active-material body. To put it differently, the decompositions of electrolytic solution do not take place at locations in a surface of the positive-electrode active-material body where the lithium-ion conduction does not take place. Consequently, at places where no adhesion portion adheres in a surface of the positive-electrode active-material body, the decompositions of electrolytic solution are less likely to occur even when a surface of the positive-electrode active-material body contacts the electrolytic solution. Therefore, in a surface of the positive-electrode active-material body, the decompositions of electrolytic solution are inhibited, as far as the adhesion portion adheres on some of the surface.

Moreover, the lithium-ion conduction in the positive-electrode active-material body is facilitated by the (ZrO)₂P₂O₇ existing on the surface. In other words, the resistance of lithium-ion secondary battery is inhibited from rising. In addition, since the resistance of lithium-ion secondary battery is inhibited from rising, the resistance is less likely to rise even when the battery is operated at a high rate. Consequently, the rate characteristic of lithium-ion secondary battery upgrades.

On the other hand, the (ZrO)₂P₂O₇ existing on a surface of the positive-electrode active-material body upgrades the initial charge/discharge efficiency. The upgrade in the initial charge/discharge efficiency is inferred to result from the fact that the (ZrO)₂P₂O₇ inhibits side reactions from taking place on the surface of electrode. In addition, the (ZrO)₂P₂O₇ existing on a surface of the positive-electrode active-material body upgrades the storage property. The upgrade in the storage property is inferred to result from the fact that the (ZrO)₂P₂O₇ inhibits side reactions from taking place on the surface of electrode.

From the viewpoint of the cyclability and the resistance of battery, a preferable proportion occupied by an area of the adhesion portion is from 4% or more to 60% or less when the total surface area of the positive-electrode active-material body is taken as 100%.

When a proportion occupied by an area of the adhesion portion is less than 4%, the cyclability is not improved. When a proportion occupied by an area of the adhesion portion is greater than 60%, the resistance of battery becomes large.

On the other hand, from the viewpoint of the initial charge/discharge efficiency and storage property, a preferable proportion occupied by an area of the adhesion portion is from 1% or more to 36% or less when the total surface area of the positive-electrode active-material body is taken as 100%. A proportion occupied by an area of the adhesion portion falling within the range results in a lithium-ion secondary battery being enhanced in both of the initial charge/discharge efficiency and the storage property.

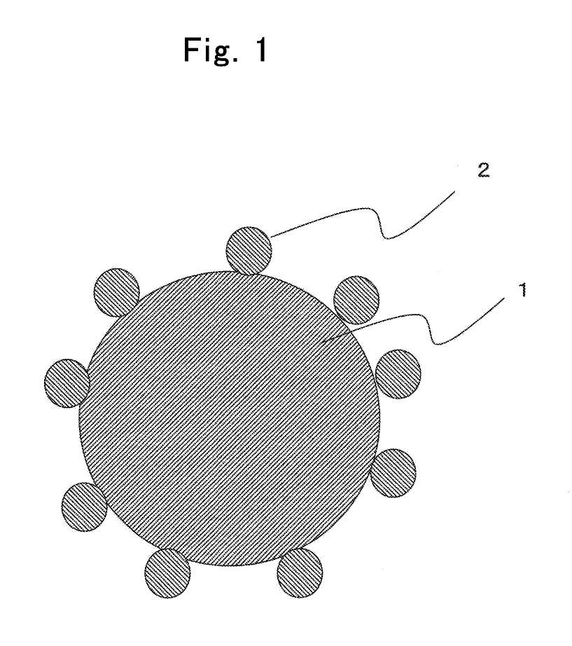

A schematic cross-sectional diagram explaining a positive-electrode active material for lithium-ion secondary battery according to one of the present examples is shown in FIG. 1. In the positive-electrode active material for lithium-ion secondary battery shown in FIG. 1, multiple adhesion portions 2 adhere on the surface of a positive-electrode active-material body 1 while intervals are provided therebetween. In the positive-electrode active material for lithium-ion secondary battery shown in FIG. 1, not only the positive-electrode active-material body 1 but also the adhesion portions 2 have a powdery configuration, respectively. An allowable configuration of the adhesion portions 2 is a lamellar shape adhering on the entirety of a surface of the positive-electrode active-material body 1, or on most of the surface.

As a method for adhering the (ZrO)₂P₂O₇ onto the positive-electrode active-material body, a dry method, and a wet method are employable.

A dry method is a method in which the positive-electrode active-material body and the (ZrO)₂P₂O₇ are mixed one another in a dry manner. For the (ZrO)₂P₂O₇, using the (ZrO)₂P₂O₇ per se is also permissible, or using a hydrate of (ZrO)₂P₂O₇ is even allowable. In the mixing, using a mortar and pestle is also allowable, using a publicly-known mixing apparatus, such as a ball-milling apparatus, for instance, is even allowable, or combining the aforementioned means suitably is also allowable.

Using a dry method leads to enabling the (ZrO)₂P₂O₇ to adhere onto the positive-electrode active-material body thickly. However, adhering the (ZrO)₂P₂O₇ onto the positive-electrode active-material body thickly results in increasing the resistance of battery, even when a proportion occupied by an area of the (ZrO)₂P₂O₇ is less with respect to the total surface area of the positive-electrode active-material body. Therefore, from the view point of the resistance of battery, setting a proportion occupied by an area of the (ZrO)₂P₂O₇ at 60% or less is preferable when the total surface area of the positive-electrode active-material body is taken as 100%, when a dry method is used.

Moreover, heating a positive-electrode active material further after the mixing is also permissible. When a hydrate of the (ZrO)₂P₂O₇ is used as a mixed material, at least some of the crystal water is removable from the hydrate of the (ZrO)₂P₂O₇ by heating the positive-electrode active material at a temperature of 150° C. or more.

A wet method is that the (ZrO)₂P₂O₇ is adhered onto the positive-electrode active-material body in a solution. For example, a solution is prepared by dissolving ZrO(NO₃)₂.2H₂O and (NH₄)₂HPO₄.6H₂O in pure water in a constant proportion one another. A powder of the positive-electrode active-material body is charged into the solution. The powder of the positive-electrode active-material body is charged negatively in the solution, whereas the powders of a (ZrO)₂P₂O₇ hydrate precipitated in the solution are charged positively. Consequently, the powders of the (ZrO)₂P₂O₇ hydrate are adsorbed onto a surface of the powder of the positive-electrode active-material body by controlling a pH of the solution. The multiple powders of the (ZrO)₂P₂O₇ hydrate repel by the positive charges one another. Consequently, the powders of the (ZrO)₂P₂O₇ hydrate are adsorbed onto a surface of the powder of the positive-electrode active-material body while being spaced at intervals. Thereafter, a positive-electrode active material for lithium-ion secondary battery according to the present invention is produced by filtering and then drying the positive-electrode active-material body in which the powders of the (ZrO)₂P₂O₇ hydrate have adsorbed on at least some of the surface. Moreover, heating the present positive-electrode active material further after the drying is also permissible. From the (ZrO)₂P₂O₇ hydrate, at least some of the crystal water is removable by heating the present positive-electrode active material at a temperature of 150° C. or more.

In a wet method, the (ZrO)₂P₂O₇ being adsorbed on a surface of the positive-electrode active-material body is not thickened. Therefore, from the viewpoint of the resistance of battery, a proportion occupied by an area of the (ZrO)₂P₂O₇ on some of a surface area of the positive-electrode active material does not matter so much in a wet method, so that the (ZrO)₂P₂O₇ is also allowed to adhere on the entire surface of the positive-electrode active-material body. From the viewpoint of the resistance of battery, setting a proportion occupied by an area of the (ZrO)₂P₂O₇ at 80% or less is more preferable when the total surface area of the positive-electrode active-material body is taken as 100%, in a wet method.

Moreover, when the aforementioned positive-electrode active material for lithium-ion secondary battery is produced via a heating step, wherein the heating temperature is from 150° C. or more to 500° C. or less, the initial charge/discharge efficiency of the present lithium-ion secondary battery becomes high. In the (ZrO)₂P₂O₇, at least some of the crystal water, which the (ZrO)₂P₂O₇ possesses inside, is decreased by being heated at a temperature of 150° C. or more. In particular, in the (ZrO)₂P₂O₇, most of the crystal water is decreased by being heated at a temperature of 400° C. or more. The less the (ZrO)₂P₂O₇ has a water content, the less the resistance of battery becomes. Consequently, the less the (ZrO)₂P₂O₇ has a water content, the higher the charged and discharged capacities of battery become. Moreover, the (ZrO)₂P₂O₇ is believed to be deteriorated by the containing water content. Consequently, the less the (ZrO)₂P₂O₇ has a water content, the more remarkable the advantageous effect of facilitating the lithium-ion conduction in the positive-electrode active-material body becomes.

Meanwhile, in the (ZrO)₂P₂O₇, in light of the results of a TG measurement measured in examples set forth below, no further reduction in the crystal water is observed even when being heated at a temperature higher than 500° C. Therefore, heating the positive-electrode active material for lithium-ion secondary battery at a temperature higher than 500° C. is not needed, so that heating the positive-electrode active material for lithium-ion secondary battery at a temperature of 500° C. or less is preferable in order to also save the waste of energy at the time of making.

### Lithium-Ion Secondary Battery

A lithium-ion secondary battery according to the present invention comprises the above-described positive-electrode active material for lithium-ion secondary battery.

A positive electrode is made by adhering a positive-electrode active-material layer, which is made by binding the aforementioned positive-electrode active material, onto a current collector.

The “current collector” refers to a chemically inactive high electron conductor for keeping an electric current flowing to electrodes during discharging or charging a lithium-ion secondary battery. As a material usable for the current collector, the following are listed, for instance: metallic materials, such as stainless steels, titanium, nickel, aluminum and copper; or electrically-conductive resins. Moreover, for the current collector, taking on forms, such as foils, sheets and films, is possible. Consequently, as the current collector, metallic foils, such as copper foils, nickel foils, aluminum foils and stainless-steel foils, are usable suitably, for instance.

A preferable thickness of a current collector is from 10 μm to 100 μm.

The positive-electrode active-material layer is allowed to further include a conductive additive. The positive electrode is formable as described below. A composition for forming the positive-electrode active-material layer is prepared: the composition includes the positive-electrode active material and a binding agent, as well as a conductive additive, if needed. In addition, the composition for forming the positive-electrode active-material layer is turned into a paste-like substance by adding a proper solvent thereto. The paste-like substance is coated onto a surface of the current collector. Thereafter, the paste-like substance is dried, thereby forming the positive-electrode active-material layer onto a surface of the current collector. Compressing the current collector with the positive-electrode active-material layer formed is also allowed in order to enhance the density of an electrode, if needed.

As for a method of coating the composition for forming the positive-electrode active-material layer, publicly-known conventional methods, such as roll coating methods, dip coating methods, doctor blade methods, spray coating methods and curtain coating methods, are allowed to use.

As a solvent for viscosity adjustment, N-methyl-2-pyrrolidone (or NMP), methanol, methyl isobutyl ketone (or MIBK), and the like, are employable.

The binding agent plays a role of fastening the aforementioned positive-electrode active material and conductive additive together onto the current collector. As the binding agent, the following are usable, for instance: fluorine-containing resins, such as polyvinylidene fluoride, polytetrafluoroethylene and fluorinated rubber; thermoplastic resins, such as polypropylene, polyethylene and polyvinyl acetate-based resins; imide-based resins, such as polyimide and polyamide-imide; and alkoxysilyl group-containing resins; as well as rubbers, such as styrene-butadiene rubber (or SBR).

The conductive additive is added in order to enhance the electrically-conducting property of electrode. As the conductive additive, the following are usable independently, or two or more of the following are combinable to use: carbonaceous fine particles, such as carbon black, graphite, acetylene black (or AB), KETJENBLACK (or KB (registered trademark)) and gas-phase-method carbon fibers (or VGCF). Although an employment amount of the conductive additive is not at all restrictive especially, setting the employment amount is possible at from 1 to 30 parts by mass approximately with respect to 100-part-by-mass active materials to be contained in the positive electrode, for instance.

### Other Constituent Elements

In addition to the above-mentioned positive electrode, the lithium-ion secondary battery according to the present invention further comprises a negative electrode, a separator, and an electrolytic solution, as the battery constituent elements.

The negative electrode comprises a current collector, and a negative-electrode active-material layer bound onto a surface of the current collector. The negative-electrode active-material layer includes a negative-electrode active material, and a binding agent, as well as a conductive additive, if needed. The current collector, the binding agent, and the conductive additive are the same as the counterparts described in the positive electrode.

As for the negative-electrode active material, the following are usable: carbon-based materials being capable of occluding and releasing (or sorbing and desorbing) lithium; elements being capable of alloying with lithium; compounds comprising an element being capable of alloying with lithium; or polymeric materials.

As for the carbon-based material, the following are given: non-graphitizable carbon, artificial graphite, cokes, graphites, glassy carbons, organic-polymer-compound calcined bodies, carbon fibers, activated carbon, or carbon blacks. Note herein that the “organic-polymer-compound calcined bodies” refer to calcined bodies carbonized by calcining polymeric materials, such as phenols and furans, at a proper temperature.

As the element being capable of alloying with lithium, the following are given: Na, K, Rb, Cs, Fr, Be, Mg, Ca, Sr, Ba, Ra, Ti, Ag, Zn, Cd, Al, Ga, In, Si, Ge, Sn, Pb, Sb, and Bi. Even among the elements, a preferable element being capable of alloying with lithium is silicon (Si), or tin (Sn).

As for the compound comprising an element being capable of alloying with lithium, the following are employable, for instance: ZnLiAl, AlSb, SiB₄, SiB₆, Mg₂Si, Mg₂Sn, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, SiOᵥ (where 0<“v”≦2), SnO_{w} (where 0<“w”≦2), SnSiO₃, LiSiO, or LiSnO. As for the compound comprising an element being capable of alloying with lithium, a silicon compound, or a tin compound is preferable. As for the silicon compound, SiOₓ (where 0.5≦“x”≦1.5) is preferable. As for the tin compound, tin alloys (such as Cu—Sn alloys and Co—Sn alloys) are preferable.

As for the polymeric material, polyacetylene, or polypyrrole is employable.

The separator is one of the constituent elements making lithium ions pass therethrough while isolating the positive electrode and negative electrode from one another and preventing the two electrodes from contacting with each other to result in electric-current short-circuiting. As the separator, the following are employable, for instance: porous membranes made of synthetic resins, such as polytetrafluoroethylene, polypropylene, or polyethylene; or porous membranes made of ceramics.

The electrolytic solution includes a solvent, and an electrolyte dissolved in the solvent.

As the solvent, cyclic esters, linear or chain-shaped esters, and ethers are employable, for instance. As the cyclic esters, the following are employable, for instance: ethylene carbonate, propylene carbonate, butylene carbonate, gamma-butyrolactone, vinylene carbonate, 2-methyl-gamma-butyrolactone, acetyl-gamma-butyrolactone, and gamma-valerolactone. As the linear esters, the following are employable, for instance: dimethyl carbonate, diethyl carbonate, dibutyl carbonate, dipropyl carbonate, ethyl methyl carbonate, alkyl propionate ester, dialkyl malonate ester, and alkyl acetate ester. As the ethers, the following are employable, for instance: tetrahydrofuran, 2-methyltetrahydrofuran, 1,4-dioxane, 1,2-dimethoxyethane, 1,2-diethoxyethane, and 1,2-dibutoxyethane.

Moreover, as the electrolyte to be dissolved in the aforementioned electrolytic solution, the following are employable, for instance: a lithium salt, such as LiClO₄, LiAsF₆, LiPF₆, LiBF₄, LiCF₃SO₃ or LiN(CF₃SO₂)₂.

As the electrolytic solution, the following solution is employable: a solution comprising a lithium salt, such as LiClO₄, LiPF₆, LiBF₄ or LiCF₃SO₃, dissolved in a concentration of from 0.5 mol/L to 1.7 mol/L approximately in a solvent, such as ethylene carbonate, dimethyl carbonate, propylene carbonate or diethyl carbonate, for instance.

Having a vehicle have the aforementioned lithium-ion secondary battery on-board is possible. Since the aforementioned lithium-ion secondary battery exhibits large charged and discharged capacities, and since the lithium-ion secondary battery exhibits a rate characteristic, cyclability and storage property which are superior, a vehicle having the lithium-ion secondary battery on-board is of high performance in terms of the output and longevity.

An allowable vehicle is a vehicle making use of electric energies produced by battery for all or some of the power source. As the vehicle, the following are given, for instance: electric automobiles, hybrid automobiles, plug-in hybrid automobiles, hybrid railroad vehicles, electric-powered forklifts, electric wheelchairs, electric-power-assisted bicycles, and electric-powered two-wheel vehicles.

Having been described so far are the embodiment modes of the positive-electrode active material for lithium-ion secondary battery according to the present invention, and the present lithium-ion secondary battery. However, the present invention is not an invention which is limited to the aforementioned embodying modes. The present invention is executable in various modes, to which changes or modifications that one of ordinary skill in the art carries out are made, within a range not departing from the gist of the present invention.

### EXAMPLES

The present invention is hereinafter described more concretely, while giving Examples thereof.

### First Example

### Making of Positive-Electrode Active Material for Lithium-Ion Secondary Battery

As a positive-electrode active-material body, LiNi_{0.5}Co_{0.2}Mn_{0.3}O₂ with an average particle of 10 μm was readied. As raw materials for an adhesion portion, ZrO(NO₃)₂.2H₂O and (NH₄)₂HPO₄.6H₂O were readied.

The ZrO(NO₃)₂.2H₂O and (NH₄)₂HPO₄.6H₂O were poured in pure water so as to make a ratio, Zr/P=1/1, and were then stirred to dissolve therein, thereby making a solution. The LiNi_{0.5}CO_{0.2}Mn_{0.3}O₂ was charged into the solution so as to make (ZrO)₂P₂O₇ in an amount of 0.1% by mass when the LiNi_{0.5}CO_{0.2}Mn_{0.3}O₂ was taken as 100% by mass, and was then stirred therein for 1 hour. The solution was subjected suction filtering, and a slurry-like filtered substance was dried with a 120° C. drier for 12 hours. The post-drying filtered substance, which had become a massive shape, was pulverized using a mortar and pestle, was put in a crucible, and was then calcined at 400° C. for 5 hours. The post-calcination filtered substance was pulverized so as to make the average particle diameter 10 μm using another mortar and pestle, thereby obtaining a positive-electrode active material for lithium-ion secondary battery according to a first example. An observation was done with a scanning-type electron microscope (or SEM) to ascertain that the adhered (ZrO)₂P₂O₇ did not come off from the positive-electrode active-material body in each of the pulverization steps, and that the adhesion state did not change before and after each of the pulverization steps.

When the completed positive-electrode active material for lithium-ion secondary battery according to the first example was observed with an SEM, such circumstances were observed that powders having a particle diameter of 500 nm approximately adhered on the surface of the LiNi_{0.5}Co_{0.2}Mn_{0.3}O₂ having a particle diameter of 10 μm while leaving spaces therebetween.

Note herein that an adhered rate (%) of the (ZrO)₂P₂O₇ was found as described below. Since the positive-electrode active-material body and the (ZrO)₂P₂O₇ particles showed distinctive light-dark differences one another in the SEM photographs, portions in which the particles adhered on the surface of the positive-electrode active-material body, and the other portions in which the particles did not adhere thereon were discernible one another definitely. A proportion occupied by an area of the (ZrO)₂P₂O₇ particles with respect to a surface area of the positive-electrode active-material body was computable by subjecting the SEM photographs to an image analysis, thereby finding the proportion occupied by the area as an adhered rate.

An adhered rate of the (ZrO)₂P₂O₇ was 4% in the positive-electrode active material for lithium-ion secondary battery according to the first example.

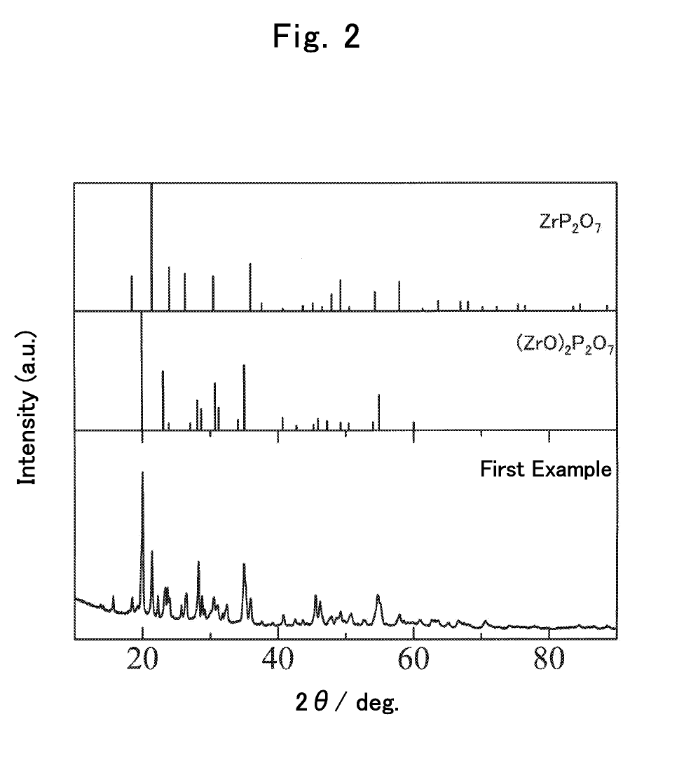

The adhered substance in the positive-electrode active material for lithium-ion secondary battery according to the first example was analyzed by powder X-ray diffraction (or XRD) (e.g., with “SmartLab” produced by RIGAKU). A result of the analysis on the adhered substance according to the first example is shown in FIG. 2 along with results of the analysis on ZrP₂O₇ and (ZrO)₂P₂O₇. According to the positions of the peaks shown in FIG. 2, the adhered substance in the positive-electrode active material for lithium-ion secondary battery according to the first example was ascertainable that the adhered substance was not ZrP₂O₇ but (ZrO)₂P₂O₇.

### Thermogravimetric Measurement of (ZrO)₂P₂O₇ (i.e., Thermogravimetry (or TG))

In order to measure, (ZrO)₂P₂O₇ was readied. ZrO(NO₃)₂.2H₂O and (NH₄)₂HPO₄.6H₂O were poured in pure water so as to make a ratio, Zr/P=1/1, and were then stirred to dissolve therein, thereby making a solution. The raw materials were stirred for 1 hour as they were. The solution was subjected suction filtering, and a filtered substance was dried with a 120° C. drier for 12 hours. The dried substance made a sample for TG measurement.

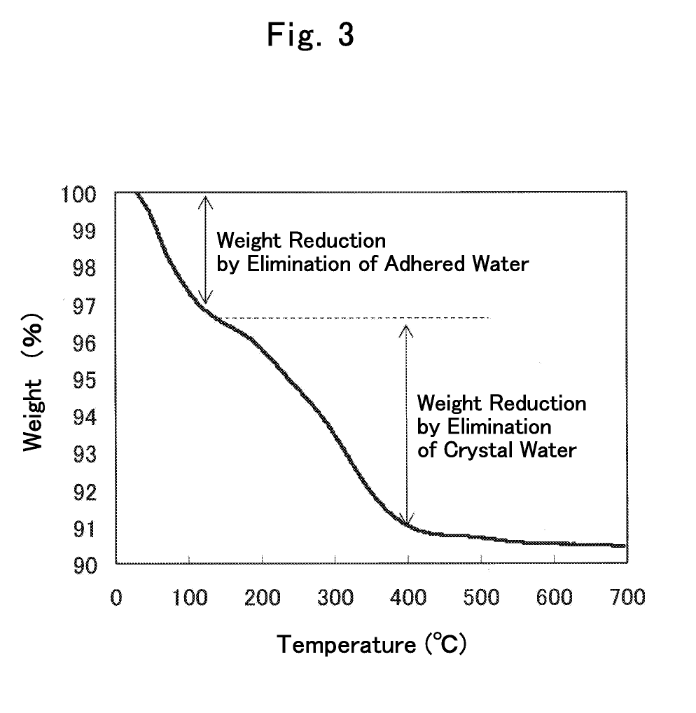

A thermogravimetric variation of the aforementioned sample was measured with a thermal analysis instrument produced by TA INSTRUMENTS Corporation. In the TG measurement, a weight variation of the sample was measured by increasing the temperature from room temperature to 700° C. at a constant rate. The original mass was taken as 100%, and masses were measured at predetermined temperatures respectively, then the masses at the predetermined temperatures were compared with the original mass to display variations in percentages. The results of the TG measurement are shown in FIG. 3.

As being noticed in FIG. 3, the (ZrO)₂P₂O₇ decreased in the weight in two stages when the temperature was being raised. The “two stages” refer to the following: the weight kept on decreasing from room temperature up to 150° C.; the decreasing extent of the weight became gentle once or temporarily at around 150° C. approximately; the weight kept on decreasing further until the temperature became from 150° C. or more to 500° C. or less; the weight variation was little seen at 500° C. or more. The weight reduction at temperatures up to 150° C. approximately is presumed to be a weight reduction resulting from the elimination of adhered water, and another weight reduction at temperatures from 150° C. or more to 500° C. or less is presumed to be another weight reduction resulting from the elimination of crystal water.

In other words, when the (ZrO)₂P₂O₇ was heated at a temperature of 150° C. or more, at least some of the crystal water was found out to go on being eliminated. In particular, when the (ZrO)₂P₂O₇ was heated at a temperature of 400° C. or more, most of the crystal water was found out to be eliminated.

### Fabricating of Laminated-Type Lithium-Ion Secondary Battery

A laminated-type lithium-ion secondary battery according to the first example was fabricated in the following manner.

First of all, the positive-electrode active material for lithium-ion secondary battery according to the first example, acetylene black serving as a conductive additive, and polyvinylidene fluoride (or PVDF) serving as a binding agent were set up in such an amount as 94 parts by mass, 3 parts by mass and 3 parts by mass, respectively, and were then mixed one another. The mixture was dispersed in a proper amount of N-methyl-2-pyrrolidone (or NMP), thereby preparing a slurry.

As a current collector, an aluminum foil with 20-μm thickness was readied. The slurry was put on the aforementioned current collector, and was then coated onto the current collector using a doctor blade so as to turn the slurry into a film shape. After drying the thus obtained sheet at 80° C. for 20 minutes in order to remove the NMP by volatilization, the current collector, and the coated substance on the current collector were firmly adhesion joined by a roll pressing machine. On the occasion, the electrode density was set so as to be 12 g/cm³. The thus joined substance was heated at 120° C. for 6 hours with a vacuum drier. The post-heating joined substance was cut out to a predetermined configuration (e.g., a rectangular shape with 25 mm×30 mm), and was labeled a positive electrode 1. The thickness of the positive electrode 1 was 60 μm approximately.

A negative electrode was made in the following manner. The following were mixed one another: 97 parts by mass of a graphite powder; 1 part by mass of acetylene black serving as a conductive additive; and 1 part by mass of styrene-butadiene rubber (or SBR) and 1 part by mass of carboxymethylcellulose (or CMC), the two serving as a binding agent. The mixture was dispersed in ion-exchanged water, thereby preparing a slurry. The slurry was coated onto a copper foil with 20-μm thickness serving as a current collector for negative electrode using a doctor blade so as to turn the slurry into a film shape. After drying the current collector with the slurry coated, the current collector was pressed. The joined substance was heated at 200° C. for 2 hours with a vacuum drier. The post-heating joined substance was cut out to a predetermined configuration (e.g., a rectangular shape with 25 mm×30 mm), and was made into a negative electrode. The thickness of the negative electrode was 45 μm approximately.

Using the above-mentioned positive electrode 1 and negative electrode, a laminated-type lithium-ion secondary battery was fabricated. Specifically, a rectangle-shaped sheet serving as a separator and composed of a polypropylene resin with 27×32 mm in size and 25 μm in thickness was interposed or held between the positive electrode 1 and the negative electrode, thereby making a polar-plate subassembly. After covering the polar-plate subassembly with laminated films in which two pieces made a pair and then sealing the laminated films at the three sides, an electrolytic solution was injected into the laminated films which had been turned into a bag shape. As the electrolytic solution, a solution was used: the solution comprised a solvent in which ethylene carbonate (or EC), and diethyl carbonate (or DEC) had been mixed one another in such a ratio as EC:DEC=3:7 by volume; and 1-mol LiPF₆ dissolved in the solvent. Thereafter, the remaining one side was sealed, thereby obtaining a laminated-type lithium-ion secondary battery in which the four sides were sealed air-tightly and in which the polar-plate subassembly and electrolytic solution were closed hermetically. Note that the positive electrode and negative electrode were equipped with a tab connectable electrically with the outside, respectively, and the tabs extended out partially to the outside of the laminated-type lithium-ion secondary battery. The laminated-type lithium-ion secondary battery according to the first example was fabricated through the above steps.

### Second Example

Other than charging the LiNi_{0.5}Co_{0.2}Mn_{0.3}O₂ so as to make the (ZrO)₂P₂O₇ in an amount of 0.5% by mass when the LiNi_{0.5}CO_{0.2}Mn_{0.3}O₂ was taken as 100% by mass in preparing the positive-electrode active material for the lithium-ion secondary battery according to the first example, a laminated-type lithium-ion secondary battery according to a second example was fabricated in the same manner as the first example.

When observing a positive-electrode active material for the lithium-ion secondary battery according to the second example by an SEM, particles with 100 nm approximately were ascertainable to adhere on a surface of the positive-electrode active-material body.

An adhered rate of the (ZrO)₂P₂O₇ was 12% in the positive-electrode active material for the lithium-ion secondary battery according to the second example.

### Third Example

Other than the following: charging the LiNi_{0.5}CO_{0.2}Mn_{0.3}O₂ so as to make the (ZrO)₂P₂O₇ in an amount of 1% by mass when the LiNi_{0.5}CO_{0.2}Mn_{0.3}O₂ was taken as 100% by mass; and not carrying out the calcination after drying the filtered substance in preparing the positive-electrode active material for the lithium-ion secondary battery according to the first example, a laminated-type lithium-ion secondary battery according to a third example was fabricated in the same manner as the first example.

When observing a positive-electrode active material for the lithium-ion secondary battery according to the third example by an SEM, particles with 100 nm approximately were ascertainable to adhere on a surface of the positive-electrode active-material body.

An adhered rate of the (ZrO)₂P₂O₇ was 36% in the positive-electrode active material for the lithium-ion secondary battery according to the third example.

### Fourth Example

Other than charging the LiNi_{0.5}CO_{0.2}Mn_{0.3}O₂ so as to make the (ZrO)₂P₂O₇ in an amount of 1% by mass when the LiNi_{0.5}CO_{0.2}Mn_{0.3}O₂ was taken as 100% by mass in preparing the positive-electrode active material for the lithium-ion secondary battery according to the first example, a laminated-type lithium-ion secondary battery according to a fourth example was fabricated in the same manner as the first example.

When observing a positive-electrode active material for the lithium-ion secondary battery according to the fourth example by an SEM, particles with 500 nm approximately were ascertainable to adhere on a surface of the positive-electrode active-material body.

An adhered rate of the (ZrO)₂P₂O₇ was 30% in the positive-electrode active material for the lithium-ion secondary battery according to the fourth example.

### Fifth Example

Other than charging the LiNi_{0.5}CO_{0.2}Mn_{0.3}O₂ so as to make the (ZrO)₂P₂O₇ in an amount of 2% by mass when the LiNi_{0.5}CO_{0.2}Mn_{0.3}O₂ was taken as 100% by mass in preparing the positive-electrode active material for the lithium-ion secondary battery according to the first example, a laminated-type lithium-ion secondary battery according to a fifth example was fabricated in the same manner as the first example.

When observing a positive-electrode active material for the lithium-ion secondary battery according to the fifth example by an SEM, particles with 500 nm approximately were ascertainable to adhere on a surface of the positive-electrode active-material body. Moreover, the presence of approximately-10-μm coarse particles not adhering on the positive-electrode active-material body was also ascertainable.

An adhered rate of the (ZrO)₂P₂O₇ was 55% in the positive-electrode active material for the lithium-ion secondary battery according to the fifth example.

### Sixth Example

Other than the following: charging the LiNi_{0.5}CO_{0.2}Mn_{0.3}O₂ so as to make the (ZrO)₂P₂O₇ in an amount of 2% by mass when the LiNi_{0.5}CO_{0.2}Mn_{0.3}O₂ was taken as 100% by mass; and putting the post-drying substance in a crucible and then calcining the compound at 700° C. for 5 hours in preparing the positive-electrode active material for the lithium-ion secondary battery according to the first example, a laminated-type lithium-ion secondary battery according to a sixth example was fabricated in the same manner as the first example.

When observing a positive-electrode active material for the lithium-ion secondary battery according to the sixth example by an SEM, particles with 500 nm approximately were ascertainable to adhere on a surface of the positive-electrode active-material body. Moreover, the presence of approximately-10-μm coarse particles not adhering on the positive-electrode active-material body was also ascertainable.

An adhered rate of the (ZrO)₂P₂O₇ was 47% in the positive-electrode active material for the lithium-ion secondary battery according to the sixth example.

### Seventh Example

Other than the following: charging the LiNi_{0.5}CO_{0.2}Mn_{0.3}O₂ so as to make the (ZrO)₂P₂O₇ in an amount of 2% by mass when the LiNi_{0.5}CO_{0.2}Mn_{0.3}O₂ was taken as 100% by mass; and putting the post-drying substance in a crucible and then calcining the compound at 1,000° C. for 5 hours in preparing the positive-electrode active material for the lithium-ion secondary battery according to the first example, a laminated-type lithium-ion secondary battery according to a seventh example was fabricated in the same manner as the first example.

When observing a positive-electrode active material for the lithium-ion secondary battery according to the seventh example by an SEM, particles with 500 nm approximately were ascertainable to adhere on a surface of the positive-electrode active-material body. Moreover, the presence of approximately-10-μm coarse particles not adhering on the positive-electrode active-material body was also ascertainable.

An adhered rate of the (ZrO)₂P₂O₇ was 45% in the positive-electrode active material for the lithium-ion secondary battery according to the seventh example.

### Eighth Example

Other than the following: charging the LiNi_{0.5}Co_{0.2}Mn_{0.3}O₂ so as to make the (ZrO)₂P₂O₇ in an amount of 5% by mass when the LiNi_{0.5}Co_{0.2}Mn_{0.3}O₂ was taken as 100% by mass; and putting the post-drying substance in a crucible and then calcining the compound at 1,000° C. for 5 hours in preparing the positive-electrode active material for the lithium-ion secondary battery according to the first example, a laminated-type lithium-ion secondary battery according to an eighth example was fabricated in the same manner as the first example.

When observing a positive-electrode active material for the lithium-ion secondary battery according to the eighth example by an SEM, particles with 500 nm approximately were ascertainable to adhere on a surface of the positive-electrode active-material body. Moreover, the presence of approximately-10-μm coarse particles not adhering on the positive-electrode active-material body was also ascertainable.

An adhered rate of the (ZrO)₂P₂O₇ was 77% in the positive-electrode active material for the lithium-ion secondary battery according to the eighth example.

### Ninth Example

Other than no calcination was carried out after drying the filtered substance in preparing the positive-electrode active material for the lithium-ion secondary battery according to the first example, a laminated-type lithium-ion secondary battery according to a ninth example was fabricated in the same manner as the first example.

When observing a positive-electrode active material for the lithium-ion secondary battery according to the ninth example by an SEM, particles with 100 nm approximately were ascertainable to adhere on a surface of the positive-electrode active-material body.

An adhered rate of the (ZrO)₂P₂O₇ was 4% in the positive-electrode active material for the lithium-ion secondary battery according to the ninth example.

### Tenth Example

Other than no calcination was carried out after drying the filtered substance in preparing the positive-electrode active material for the lithium-ion secondary battery according to the second example, a laminated-type lithium-ion secondary battery according to a tenth example was fabricated in the same manner as the second example.

When observing a positive-electrode active material for the lithium-ion secondary battery according to the tenth example by an SEM, particles with 500 nm approximately were ascertainable to adhere on a surface of the positive-electrode active-material body.

An adhered rate of the (ZrO)₂P₂O₇ was 15% in the positive-electrode active material for the lithium-ion secondary battery according to the tenth example.

### First Comparative Example

Other than the following: pouring Al(NO₃)₃.9H₂O, instead of ZrO(NO₃)₂.2H₂O, in pure water; and charging the LiNi_{0.5}Co_{0.2}Mn_{0.3}O₂ into the solution so as to make the AlPO₄ in an amount of 2% by mass when the LiNi_{0.5}CO_{0.2}Mn_{0.3}O₂ was taken as 100% by mass in preparing the positive-electrode active material for the lithium-ion secondary battery according to the first example, a laminated-type lithium-ion secondary battery according to a first comparative example was fabricated in the same manner as the first example.

When observing a positive-electrode active material for the lithium-ion secondary battery according to the first comparative example by an SEM, particles with 500 nm approximately were ascertainable to adhere on a surface of the active material.

An adhered rate of AlPO₄ was 27% in the positive-electrode active material for the lithium-ion secondary battery according to the first comparative example.

### Second Comparative Example

Other than employing the LiNi_{0.5}CO_{0.2}Mn_{0.3}O₂ with no adhered substance, namely, the compound per se, a laminated-type lithium-ion secondary battery according to a second comparative example was fabricated in the same manner as the first example.

### Evaluation of Rate Characteristic

The rate characteristics of the laminated-type lithium-ion secondary batteries according to the second example and the second comparative example were measured, respectively, at 25° C. The voltage range was set within a range of from 4.5 V to 3.0 V, and the current rate at which the batteries were discharged for 1 hour was labeled 1 C. Discharged capacities of the batteries were measured when a current rate was 0.33 C and 1 C. The capacity when the current rate was 0.33 C was taken as a standard, and then a proportion, namely, (the 1 C capacity)/(the 0.33 C capacity), was displayed.

In addition, the post-100-cycle-test rate characteristics were measured, respectively, when a current rate was 0.33 C and 1 C. In the cycle test, charging and discharging operations were repeated under the following conditions. Upon charging, CCCV charging (i.e., constant-current constant-voltage charging) was done with a voltage of 4.5 V at each of the rates at 25° C. In the CV charging, the batteries were retained at the voltage of 4.5 V for 1 hour. Upon discharging, CC discharging (i.e., constant-current discharging) was carried out with 3.0 V at each of the rates. The charging and discharging operations were labeled one cycle, and the cycle test was carried out up to 100 cycles. The respective post-100-cycle-test discharged capacities were measured when a current rate was 0.33 C and 1 C. The capacity when the current rate was 0.33 C was taken as a standard, and then a proportion, namely, (the 1 C capacity)/(the 0.33 C capacity), was displayed.

The results are shown in Table 1.

TABLE 1

Capacity Ratio
(i.e., 1 C/0.33 C)

| | Initial | After 100 Cycles |
|---|---|---|
| Second Comp. | 0.92 | 0.88 |
| Example | | |
| Second Example | 0.95 | 0.91 |

As shown in Table 1, the laminated-type lithium-ion secondary battery according to the second example employing the positive-electrode active-material body on which the (ZrO)₂P₂O₇ adhered had an enlarged capacity ratio initially and even after 100 cycles, compared with the laminated-type lithium-ion secondary battery according to the second comparative example employing the positive-electrode active material per se. From the enlarged capacities, the following were understood: adhering the (ZrO)₂P₂O₇ on a surface of the positive-electrode active-material body leads to not lowering the discharged capacity even when a high output is applied; and the advantageous effect does not vary even after the cycle test. Although the test was carried out herein up to 1 C, the advantageous effect is predicted to be seen more remarkably when the rate becomes such a high rate as 3 C, 4 C, and so on.

### Evaluation of Cyclability

The cyclabilities of the laminated-type lithium-ion secondary batteries according to the first through eighth examples, the first comparative example and the second comparative example were evaluated, respectively. As for evaluating the cyclabilities, a cycle test in which charging and discharging operations were repeated under the following conditions was carried out. Upon charging, CCCV charging (i.e., constant-current constant-voltage charging) was done with a voltage of 4.5 V at predetermined rates, respectively, at 25° C. In the CV charging, the batteries were retained at the voltage of 4.5 V for 1 hour. Upon discharging, CC discharging (i.e., constant-current discharging) was carried out with 3.0 V at predetermined rates, respectively. The charging and discharging operations were labeled one cycle, and were repeated up to 100 cycles. First-round discharged capacities, and post-100-cycle discharged capacities were measured at a rate of 1 C. The first-round discharged capacities were labeled an initial capacity, respectively, and the post-100-cylce discharged capacities were labeled a post-cycle discharged capacity, respectively. A cycle-test maintained-capacity rate was found by the following equation.

Cycle-test Maintained-capacity Rate(%)={(Post-cycle Capacity)/(Initial Capacity)}×100

Table 2 shows the type of the adhered material, the addition amount of the adhered material, the calcination temperature, the adhered rate, and the cycle-test maintained-capacity rate in each of the examples and comparative examples.

TABLE 2

| | | | | | Cycle-test |
|---|---|---|---|---|---|
| | | Addition | Calcination | | Maintained- |
| | Adhered | Amount | Temperature | Adhered | capacity |
| | Material | (% by mass) | (° C.) | Rate (%) | Rate (%) |
| First Example | (ZrO)₂P₂O₇ | 0.1 | 400 | 4 | 81 |
| Second Example | (ZrO)₂P₂O₇ | 0.5 | 400 | 12 | 86 |
| Third Example | (ZrO)₂P₂O₇ | 1 | — | 36 | 92 |
| Fourth Example | (ZrO)₂P₂O₇ | 1 | 400 | 30 | 88 |
| Fifth Example | (ZrO)₂P₂O₇ | 2 | 400 | 55 | 85 |
| Sixth Example | (ZrO)₂P₂O₇ | 2 | 700 | 47 | 79 |
| Seventh Example | (ZrO)₂P₂O₇ | 2 | 1000 | 45 | 76 |
| Eighth Example | (ZrO)₂P₂O₇ | 5 | 1000 | 77 | 59 |
| First Comp. | AlPO₄ | 2 | 400 | 27 | 77 |
| Example | | | | | |
| Second Comp. | None | — | — | — | 75 |
| Example | | | | | |

From the results shown in Table 2, the cyclabilities of the laminated-type lithium-ion secondary batteries according to the first through seventh examples were understood that the post-cycle maintained-capacity rates were high, compared with the cyclability of the laminated-type lithium-ion secondary battery according to the second comparative example using the positive-electrode active material free from the adhered substance.

Moreover, even when being compared with the post-cycle maintained-capacity rate of the laminated-type lithium-ion secondary battery according to the first comparative example using the positive-electrode active material with the AlPO₄ adhered, the post-cycle maintained-capacity rates of the laminated-type lithium-ion secondary batteries according to the first through sixth examples were understood to be high. The laminated-type lithium-ion secondary battery according to the first comparative example is the battery set forth in Patent Application Publication No. 1 (i.e., Japanese Unexamined Patent Publication (KOKAI) Gazette No. 2003-7299). The reason why the batteries according to the first through sixth examples in which the adhered substance was the (ZrO)₂P₂O₇ exhibited higher post-cycle maintained-capacity rates than did the battery according to the first comparative example in which the adhered substance was the AlPO₄ is believed to result from the fact that the lithium-ion conductivity of the (ZrO)₂P₂O₇ is higher than the lithium-ion conductivity of the AlPO₄. However, the reason is also believed to arise from the structural difference between the adhered substances. Consequently, a definite reason why the batteries had the high post-cycle maintained-capacity rates has not been clear yet.

According to the comparison between the laminated-type lithium-ion secondary batteries according to the third example and the fourth example, the adhered rate was smaller in the fourth example than in the third example when comparing the adhered rate in the third example using the active material not subjected to the calcination treatment with the adhered rate in the fourth example using the active material calcined at 400° C. From the fact, the adhered rate of the adhered substance was understood to lower by calcination. And, as accompanied by the lowering adhered rate, the maintained-capacity rate also lowered. According to the comparison between the fifth example, the sixth example and the seventh example as well, the above led to the understanding that, as the calcination temperature rises, not only the adhered rate lowers but also the maintained-capacity rate lowers. The fact results in the understanding that the higher the adhered rate is the higher the post-cycle maintained-capacity rate is.

However, note herein that the comparison between the seventh example and the eighth example leads to the understanding that, although the adhered rate rises when making the addition amount great, the post-cycle maintained-capacity rate lowers. When comparing the eighth example with the seventh example in which the addition amount of the (ZrO)₂P₂O₇ was 2% by mass, the eighth example had such a very enlarged addition amount of 5% by mass. From the results of the observations on the positive-electrode active materials for the lithium-ion secondary batteries according to the seventh example and the eighth example, the amount of 10-μm coarse particles not adhering on the positive-electrode active-material body was found out to be greater in the eighth example than in the seventh example. The finding results in such a presumption that the eighth example had the lowered post-cycle maintained-capacity rate because the 10-μm coarse particles not adhering on the positive-electrode active-material body were present in a large amount for some reason.

### Measurement of Initial Charge/Discharge Efficiency

Using the laminated-type lithium-ion secondary batteries according to the first example, the second example, the third example, the fourth example, the ninth example, the tenth example and the second comparative example, the initial charged and discharged capacities were measured, respectively.

The measurement of the initial charged and discharged capacities was carried out in the following manner. In charging, after doing CC charging (i.e., constant-current charging) at a rate of 1 C up to a voltage of 4.5 V at room temperature, CV charging (i.e., constant-voltage charging) was done with the voltage of 4.5 V for 1.5 hours. The 1 C-rate charged capacities on the occasion were measured, and were labeled an initial charged capacity, respectively.

In discharging, CC discharging (i.e., constant-current discharging) was done at a rate of 0.33 C down to a voltage of 3.0 V, and then CV discharging was done with the voltage of 3.0 V for 2 hours. Thereafter, the discharged capacities at the rate of 0.33 C were measured, and were labeled an initial discharged capacity, respectively.

A charge/discharge efficiency (%) was found by the following equation.

Charge/discharge Efficiency(%)={(Initial Discharged Capacity)/(Initial Charged Capacity)}×100

The results are shown in Table 3.

TABLE 3

| | | | | Initial | Initial | |
|---|---|---|---|---|---|---|
| | Addition | Calcination | | Charged | Discharged | Charge/discharge |
| | Amount | Temperature | Adhered Rate | Capacity | Capacity | Efficiency |
| | (% by mass) | (° C.) | (%) | (mAh/g) | (mAh/g) | (%) |
| Ninth Example | 0.1 | Uncalcined | 4 | 214.5 | 209.9 | 97.9 |
| First Example | 0.1 | 400 | 4 | 214.9 | 210.1 | 97.8 |
| Tenth Example | 0.5 | Uncalcined | 15 | 212.3 | 207.2 | 97.6 |
| Second Example | 0.5 | 400 | 12 | 214.7 | 211.2 | 98.4 |
| Third Example | 1 | Uncalcined | 36 | 205.6 | 200.1 | 97.3 |
| Fourth Example | 1 | 400 | 30 | 214.6 | 211.0 | 98.4 |
| Fifth Example | 2 | 400 | 55 | 198.0 | 189.7 | 95.8 |

| | | | | | |
|---|---|---|---|---|---|
| Second Comp. | No Treatment | — | 215.9 | 208.5 | 96.6 |
| Example | | | | | |

From Table 3, the laminated-type lithium-ion secondary batteries according to the ninth example, the first example, the tenth example, the second example, the third example and the fourth example were understood to have higher charge/discharge efficiencies (%) than did the laminated-type lithium-ion secondary battery according to the second comparative example. In other words, the adhered rate of the (ZrO)₂P₂O₇ being 36% or less was found out to lead to being high in the initial charge/discharge efficiency.

Moreover, the initial charged capacities of the laminated-type lithium-ion secondary batteries according to the first example, the second example and the fourth example using the positive-electrode active material to which the calcination had been carried out 400° C. became higher values than the laminated-type lithium-ion secondary batteries according to the ninth example, the tenth example and the third example using the uncalcined positive-electrode active material. The fact results in the presumption that the initial charged capacities became high because the resistances of the batteries were made less by using the positive-electrode active material calcined at 400° C. than by using the uncalcined positive-electrode active material.

### Measurement of Storage Property

Using the laminated-type lithium-ion secondary batteries according to the first example, the second example, the fourth example and the second comparative example, a storage-property test was carried out. First of all, a conditioning treatment was carried out to the respective laminated-type lithium-ion secondary batteries. In the conditioning treatment, charging and discharging operations were carried out repeatedly three times at 25° C. with a predetermined voltage and at a predetermined rate.

The measurement of initial discharged capacities was carried out in the following manner. In charging, CC charging (i.e., constant-current charging) was done at a rate of 1 C up to a voltage of 4.5 V at room temperature, and then CV charging (i.e., constant-voltage charging) was done with the voltage of 4.5 V for 2.5 hours. In discharging, CC discharging (i.e., constant-current discharging) was done at a rate of 0.33 C down to a voltage of 3.0 V, and then CV discharging was done with the voltage of 3.0 V for 5 hours. Thereafter, the discharged capacities at the rate of 0.33 C were measured, and were labeled an initial discharged capacity, respectively.

A storage-property test was carried out as set forth below. After charging the respective laminated-type lithium-ion secondary batteries to 4.32 V, and were stored at 60° C. as such. After taking out the batteries six days later to cool, the discharged capacities were measured in the same manner as the measurement of the initial discharged capacities. The discharged capacities were labeled a post-6-day discharged capacity, respectively.

A storage-property-test maintained-capacity rate (%) was found by the following equation.

Storage-property-test Maintained-capacity Rate(%)={(Post-6-day Discharged Capacity)/(Initial Discharged Capacity)}×100

The results are shown in Table 4.

TABLE 4

| | | | | Initial | Post-6-day | Storage- |
|---|---|---|---|---|---|---|
| | Addition | Calcination | Adhered | Discharged | Discharged | property-test |
| | Amount | Temperature | Rate | Capacity | Capacity | Maintained-capacity |
| | (% by mass) | (° C.) | (%) | (mAh/g) | (mAh/g) | Rate (%) |
| Ninth | 0.1 | Uncalcined | 4 | 210 | 186 | 88.6 |
| Example | | | | | | |
| First | 0.1 | 400 | 4 | 210 | 185 | 88.1 |
| Example | | | | | | |
| Tenth | 0.5 | Uncalcined | 15 | 207 | 185 | 89.3 |
| Example | | | | | | |
| Second | 0.5 | 400 | 12 | 211 | 185 | 87.6 |
| Example | | | | | | |
| Third | 1 | Uncalcined | 36 | 200 | 180 | 90.0 |
| Example | | | | | | |
| Fourth | 1 | 400 | 30 | 211 | 183 | 86.7 |
| Example | | | | | | |
| Fifth | 2 | 400 | 55 | 190 | 152 | 80.1 |
| Example | | | | | | |

| | | | | | |
|---|---|---|---|---|---|
| Second | No Treatment | — | 209 | 177 | 84.9 |
| Comp. | | | | | |
| Example | | | | | |

From Table 4, the laminated-type lithium-ion secondary batteries according to the first example, the second example, the third example, the fourth example, the ninth example and the tenth example were understood to have higher maintained-capacity rates (%) after having been stored at 60° C. for 6 days than did the laminated-type lithium-ion secondary battery according to the second comparative example.

While storing a laminated-type lithium-ion secondary battery at such a temperature as 60° C., various side reactions are likely to occur inside the battery, especially, in the vicinity of the positive electrode. For example, decompositions of the electrolytic solution take place during the storage so that the charged and discharged capacities decline. The fact that the adhesion portion composed of the (ZrO)₂P₂O₇ adhered on the positive-electrode active-material body was understood to inhibit such decompositions of the electrolytic solution even at a high temperature like 60° C. And, the advantageous effect was found out to be seeable especially remarkably when the addition amount was 1% by mass or less. In other words, regarding the storage property at 60° C., when the adhered rate of the (ZrO)₂P₂O₇ onto the positive-electrode active-material body was 36% or less, the storage property at 60° C. was found out to become high.

1-7. (canceled)

8. A positive-electrode active material for lithium-ion secondary battery, the positive-electrode active material comprising:
a positive-electrode active-material body; and
an adhesion portion adhering on at least some of a surface of the positive-electrode active-material body;
the adhesion portion composed of a compound expressed by a chemical formula: (ZrO)₂P₂O₇;
a proportion occupied by an area of said adhesion portion is from 1% or more to 36% or less when the total surface area of said positive-electrode active-material body is taken as 100%;
said positive-electrode active-material body is composed of a lithium-containing compound expressed by a chemical formula: LiMO₂ (where “M” is at least one member selected from the group consisting of Ni, Co and Mn).

9. The positive-electrode active material for lithium-ion secondary battery as set forth in claim 8 produced via a heating step, wherein the heating is done at a temperature of from 150° C. or more to 500° C. or less.

10. The positive-electrode active material for lithium-ion secondary battery as set forth in claim 8, wherein said positive-electrode active-material body is composed of the lithium-containing compound expressed by a chemical formula: LiCoₚNi_{q}MnᵣO₂ (where “p”+“q”+“r”=1; 0<“p”<1; 0<“q”<1; and 0<“r”<1).

11. A lithium-ion secondary battery comprising the positive-electrode active material for lithium-ion secondary battery as set forth in claim 8.
